(19) United States
(12) Patent Application Publication
(10) Pub. No.: US 2021/0067525 A1
(43) Pub. Date: Mar. 4, 2021

(54) SYSTEM AND METHOD FOR NETWORK SECURITY PERFORMING ADAPTIVE RULE-SET SETTING

(71) Applicant: XABYSS INC., Seoul (KR)

(72) Inventor: Si Young LEE, Daejeon (KR)

(21) Appl. No.: 16/958,674

(22) PCT Filed: Dec. 27, 2017
(86) PCT No.: PCT/KR2017/015523

§ 371 Date: Jun. 26, 2020

(51) Int. Cl. H04L 29/06

(52) U.S. Cl. CPC H04L 63/1416; H04L 63/1425; H04L 63/0245; H04L 63/20; H04L 63/1466

(57) ABSTRACT

A network security system performing adaptive rule-set setting, and a method therefor. The network security method includes: a step of performing a trespass detection or prevention process to detect a security threat according to a preset applicable security rule-set among a plurality of packets that a network security system receives from a network, or to enable only a permitted packet to pass, and a packet storage process to selectively store at least a part of the plurality of packets; and a step in which the network security system changes the applicable security rule-set to be applied to the trespass detection or prevention process from a first security so rule-set to a second security rule-set on the basis of the stored packets stored through the packet storage process.

### CROSS-REFERENCE TO RELATED APPLICATION

This application is a National Stage Entry of International Application No. PCT/KR2017/015523, filed on Dec. 27, 2017 of which is hereby incorporated by reference for all purposes as if fully set forth herein.

### BACKGROUND

### Field

Embodiments relate to a network security system of performing adaptive ruleset setting (hereinafter referred to as a “network security system”) and a method of performing adaptive ruleset setting, and more particularly, the present invention relates to a network security system and method capable of adaptively or autonomously controlling a security policy.

### Discussion of the Background

Efforts for pieces of the existing network control and management equipment have been made to achieve routing, quality of service (QoS), or the prevention of a distributed denial of service (DDoS), that is, specific unit targets of the pieces of corresponding equipment based on packet information of a transmission control protocol (TCP)/user datagram protocol (UDP) or Internet protocol (IP). However, a packet-based access method neglects pieces of information based on a communication relation between higher applications and simply depends on only pieces of information in included in each separated packet, that is, a temporary information transport unit. Accordingly, the packet-based access method is provided in the form of a single system for an independent target, such as a router for packet routing, a dedicated system for preventing a DDoS attack or a deep packet inspection (DPI) system for traffic control due to the limitedness of a processing speed a little and the limit of applicability a lot. Among them, the DPI system adopts a method of detecting a well-known port number and the signature of payload used by a specific application or client (e.g., P2P client or network security threat) and controlling a detected packet. By detecting such a signature, what a client, that is, application, generates a packet in a current network and/or allows the packet to pass therethrough can be aware, and proper network control is performed according to a given policy.

However, for high security, the DPI system has to inspect the payload of all packets ideally, but there is a disadvantage in that processing overhead is too great. That is, there is a problem in that high-speed and expensive equipment is necessary to inspect the payload of all the packets. Moreover, if the payload is an encrypted packet, the signature may not be detected because there is no method of decrypting the encrypted packet. Furthermore, there are problems in that it is not guaranteed to find out a signature and it is actually difficult to find out all signatures although packets have not been encrypted.

Accordingly, actually, an intrusion detection system (IDS) and an intrusion prevention system (IPS), that is, a kind of the DPI system, apply only some of a known security policy. That is, the IDS is a system that inspects packets passing through a network, determines whether there is security intrusion, and gives a warning. The IPS is a system that transmits only a packet permitted in terms of a security policy among packets passing through a network. Although such systems even become high specifications and high performance, if the system inspect all known security policies (security rulesets) and allow only a packet, not having a problem as a result of the inspection, to pass therethrough, the network speed is inevitably degraded due to the rapid progress of the recent network speed.

Accordingly, only some of known security rulesets can be inevitably applied at inspection timing. A security manager in an organization must determine whether a security policy suitable for the organization has been set, and must take an action for a change in the security threat trend that continues to vary one by one.

Furthermore, in order to remove a security vacuum attributable to a not-applied rule because only some of the known security rulesets are applied, all packets that pass through a current network must be stored and then inspection must be performed again using all the known security rulesets. In order to store the packets for the inspection, many packets must be stored. This is almost an impossible job and requires a very high cost.

### Prior Art Document

### Patent Document

Korean Patent Application (Application No. 10-2008-0126888, “Network control system and method of network control”)

Korean Patent Application (Application No. 10-2011-0019891, “System for network inspection and providing method thereof”)

The above information disclosed in this Background section is only for enhancement of understanding of the background of the invention and, therefore, it may contain information that does not constitute prior art.

### SUMMARY

The present invention is an invention made to solve such problems, and an object of the present invention is to provide a technical spirit in which an action can be taken in response to a change in the threat trend by adaptively changing an applied security ruleset in a network security system for inspecting packets in real time and allowing only a packet, not having a problem as a result of the inspection, to selectively pass therethrough.

Furthermore, an object of the present invention is to provide a technical spirit in which all or most of rulesets can be inspected through very efficient packet storage and a security ruleset applied based on the latest security threat can be automatically changed.

Furthermore, an object of the present invention is to provide a technical spirit in which packets can be inspected at a high speed and also only an initial preceding packet of a session can be inspected, so security inspection can be performed in real time.

Furthermore, an object of the present invention is to provide a technical spirit capable of significantly reducing the number of packets stored in order to record a network and supporting high-speed packet search.

Furthermore, an object of the present invention is to provide a method and system, which can significantly reduce the number of packets stored for recording a network, enables network recording for the past long time because there is no difference in performance in inspecting the network, can inspect current network packets within a short time in real time if a network inspection rule is set, and can inspect even the past network within a short time.

According to an aspect of the present invention, a method of providing a network inspection system for solve the technical problem includes the steps of performing, by a network security system, an intrusion detection or prevention process of detecting a security threat or allowing only a permitted packet to pass therethrough among a plurality of packets received from a network based on a preset applicable security ruleset and a packet storage process of selectively storing at least some of the plurality of packets, and changing, by the network security system, the applicable security ruleset to be applied to the intrusion detection or prevention process from a first security ruleset to a second security ruleset based on storage packets stored through the packet storage process.

The step of performing, by the network security system, the intrusion detection or prevention process of detecting a security threat or allowing only a permitted packet to pass therethrough among the plurality of packets received from the network based on the preset applicable security ruleset and the packet storage process of selectively storing at least some of the plurality of packets may include the step of performing, by the network security system, the packet storage process of storing only N (N is a natural number) preceding packets of a session among session setup packets forming the session from the plurality of packets.

The step of changing, by the network security system, the applicable security ruleset to be applied to the intrusion detection or prevention process from the first security ruleset to the second security ruleset based on the storage packets stored through the packet storage process may include the steps of performing security inspection on the storage packets stored for a given period, and changing the applicable security ruleset to be applied to the intrusion detection or prevention process from the first security ruleset to the second security ruleset based on a result of the execution of the security inspection.

The step of changing the applicable security ruleset to be applied to the intrusion detection or prevention process from the first security ruleset to the second security ruleset based on a result of the execution of the security inspection may include the steps of determining at least one second security rule to be included in the second security ruleset based on a result of the execution of the security inspection, and specifying the second security ruleset by newly adding the determined at least one second security rule to the first security ruleset or substituting the determined at least one second security rule with at least one first security rule included in the first security ruleset.

The step of newly adding the determined at least one second security rule to the first security ruleset or substituting the determined at least one second security rule with the at least one first security rule included in the first security ruleset and specifying the second security ruleset may include the step of determining the at least one first security rule to be substituted in order of a least recently used security rule by which a security threat has not been detected among security rules included in the first security ruleset.

The network security method of performing adaptive ruleset setting may further include the step of changing the period based on a result of the execution of the security inspection or changing the number of security rules to be included in the applicable security ruleset.

The network security method of performing adaptive ruleset setting may further include the steps of generating, by the network security system, a plurality of flows formed by the plurality of packets based on the plurality of packets, and extracting, by the network security system, at least one session setup flow forming an identical session among the plurality of flows based on information on the plurality of generated flows and specifying session information and the preceding packet based on the extracted session setup flow.

A method for solve the technical problem includes the steps of performing, by a network security system, a packet storage process of selectively storing at least some of a plurality of packets received from a network, and detecting, by the network security system, a security threat based on a preset applicable security ruleset or changing, from a first security ruleset to a second security ruleset, the applicable security ruleset to be applied to an intrusion detection or prevention process of or allowing only a permitted packet to pass therethrough.

A system for solve the technical problem includes an intrusion detection/prevention module performing an intrusion detection or prevention process of detecting a security threat or allowing only a permitted packet to pass therethrough based on a preset applicable security ruleset among a plurality of packets received from a network, a packet storage module performing a packet storage process of selectively storing at least some of the plurality of packets, and a control module for changing, from a first security ruleset to a second security ruleset, an applicable security ruleset to be applied to the intrusion detection or prevention process based on storage packets stored through the packet storage process.

The packet storage module may perform the packet storage process of storing only

N (N is a natural number) preceding packets of a session among session setup packets forming the session from the plurality of packets.

The control module may perform security inspection on the storage packets stored for a given period, and may change the applicable security ruleset to be applied to the intrusion detection or prevention process from the first security ruleset to the second security ruleset based on a result of the execution of the security inspection.

The control module may determine at least one second security rule to be included in the second security ruleset based on a result of the execution of the security inspection, and may specify the second security ruleset by newly adding the determined at least one second security rule to the first security ruleset or substituting the determined at least one second security rule with at least one first security rule included in the first security ruleset.

The control module may determine the at least one first security rule to be substituted in order of a least recently used security rule by which a security threat has not been detected among security rules included in the first security ruleset.

The control module may change the period based on a result of the execution of the security inspection or change the number of security rules to be included in the applicable security ruleset.

According to the technical spirit of the present invention, there are effects in that an action can be taken in response to a change in the threat trend by adaptively changing an applied security ruleset and therefore a security operation can be efficiently performed even without separate manpower in a network security system for detecting a security threat by inspecting packets in real time or allowing only a packet, not having a problem as a result of the inspection, to selectively pass therethrough.

Furthermore, there are effects in that inspection of all or most of rulesets can be effectively performed and an applied security ruleset can be automatically changed based on the latest security threat.

Furthermore, there is an effect in that security inspection can be performed in real time in a high-speed network environment because packets can be inspected at a high speed, information on a flow and a session based on a flow can be generated, and thus only a specific number of initial preceding packets of a session can be inspected.

Furthermore, there are effects in that the number of stored packets necessary to record a network can be significantly reduced and high-speed packet search can be supported based on session information and flow information.

Furthermore, there is an effect in that a network can be recorded for a long time even in the same physical environment because the number of stored packets necessary to record the network is reduced.

Furthermore, there are effects in that the execution of real-time security inspection is excellent due to such recording of a network and whether there was a network attack in the past can also be verified.

### BRIEF DESCRIPTION OF THE DRAWINGS

A brief description of the drawings is provided so that the drawings cited in the detailed description of the present invention are sufficiently understood.

FIG. 1 is a diagram showing a schematic configuration of a network security system according to an embodiment of the present invention.

FIG. 2 is a diagram for schematically describing a network security method according to an embodiment of the present invention.

FIG. 3 is a diagram for describing a session, a flow, and packets for a method of providing a network security system according to an embodiment of the present invention.

FIG. 4 is a diagram for describing a concept in which packet search according to a method of providing a network security system according to an embodiment of the present invention is performed.

FIG. 5 is a diagram for describing an effect according to a method of providing a network security system according to an embodiment of the present invention.

FIGS. 6A, 6B, 6C, 6D, and 6E are diagrams for describing a plurality of packet storage modes through a method of providing a network security system according to an embodiment of the present invention.

FIGS. 7A and 7B are diagrams for describing a concept in which the past network attack can be effectively inspected according to an embodiment of the present invention.

### DETAILED DESCRIPTION OF THE ILLUSTRATED EMBODIMENTS

The present invention may be changed in various ways and may have various embodiments. Specific embodiments are illustrated in the drawings and are described in detail through the detailed description. It is however to be understood that the present invention is not intended to be limited to the specific embodiments and the present invention includes all changes, equivalents and substitutions which fall within the spirit and technological scope of the present invention. In describing the present invention, a detailed description of related known functions or elements will be omitted if it is deemed to make the gist of the present invention unnecessarily vague.

Terms, such as the first and the second, may be used to describe various elements, but the elements should not be restricted by the terms. The terms are used to only distinguish one element from the other element.

The terms used in this application are used to describe specific embodiments only and are not intended to restrict the scope of right. An expression of the singular number includes an expression of the plural number unless clearly defined otherwise in the context.

It is to be understood that in this application, a term, such as include or have, is intended to designate that a characteristic, number, step, operation, element, part or a combination of them described in the specification is present, and does not exclude the presence or addition possibility of one or more other characteristics, numbers, steps, operations, elements, parts, or combinations of them in advance.

Furthermore, in this specification, if one element “transmits” data to the other element, this means that one element may directly transmit the data to the other element or may transmit the data to the other element through at least another element. In contrast, if one element “directly transmits” data to the other element, this means that the data is transmitted from one element to the other element without the intervention of another element.

Hereinafter, the present invention is described in detail based on embodiments of the present invention with reference to the accompanying drawings. The same reference numerals described in drawings refer to the same elements.

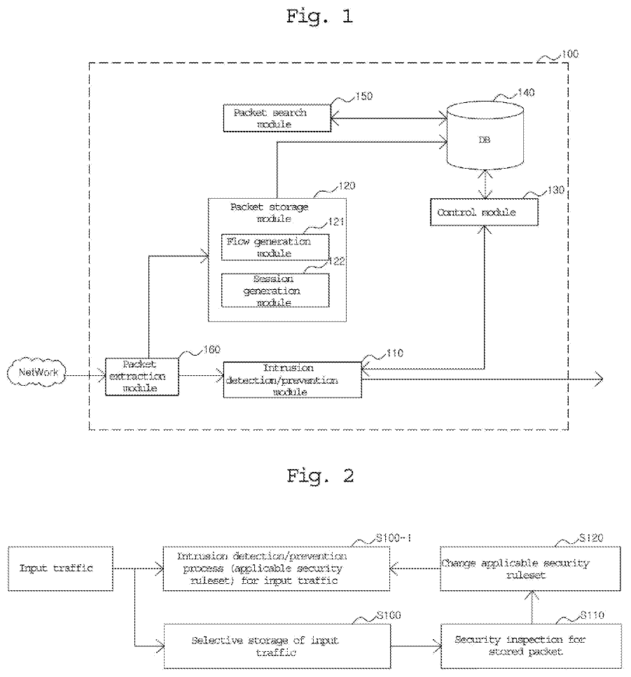

FIG. 1 is a diagram showing a schematic configuration of a network security system according to an embodiment of the present invention.

Referring to FIG. 1, the network security system 100 according to an embodiment of the present invention includes an intrusion detection/prevention module 110, a packet storage module 120, and a control module 130. The network security system 100 may further include a DB 140 and/or a packet search module 150.

According to another embodiment, the network security system 100 may include the packet storage module 120 and the control module 130. Such a case may be a case to which the network security system 100 is applied in order to apply the technical spirit of the present invention to the existing already-constructed IDS or IPS system (e.g., the intrusion detection/prevention module 110).

Meanwhile, in order to implement the technical spirit of the present invention, a packet extraction module 160 may be further included. The packet extraction module 160 may receive a plurality of packets from a network. The packet extraction module 160 is installed at a given location in the network, and may collect packets moving over the network and distribute the packets to the intrusion detection/prevention module 110 and the packet storage module 120. The distributed packets may be the same. According to an example, the packet extraction module 160 may be implemented to include equipment for tapping packets from the network.

The packet extraction module 160 is positioned at the front end and/or rear end of a gateway present in a given local area network (LAN), for example, and may inspect the network according to the technical spirit of the present invention. Accordingly, the network security system 100 may control the network/traffic based on the use of inspection results. To control the network/traffic may mean an artificial behavior of adjusting a bandwidth or a transmission speed for each given session, flow and/or packet or blocking transmission. The packet extraction module 160 may be implemented as a given network interface card (NIC), for example, but the present invention is not limited thereto.

The packet extraction module 160 may transmit the received packets to the intrusion detection/prevention module 110 and the packet storage module 120.

The intrusion detection/prevention module 110 may perform at least one of an intrusion detection process of detecting intrusion by performing packet inspection in real time based on an applicable security ruleset or an intrusion prevention process of allowing a packet to selectively pass therethrough based on a result of intrusion detection. If both the intrusion detection process and the intrusion prevention process are performed, the intrusion detection/prevention module 110 can allow only a packet, not having a problem as a result of packet inspection, to selectively pass therethrough. The intrusion detection/prevention module 110 may at least perform the intrusion detection process of performing packet inspection in real time, and may selectively further perform the intrusion prevention process.

The applicable security ruleset may be some of all sets, that is, a full ruleset of applicable security rulesets that are known at inspection timing, that is, stored in the network security system 100. The security ruleset may mean a ruleset including a plurality of security rules. Furthermore, each of the security rules may include a rule, that is, a criterion for security inspection. For example, at least one of rules by which bit streams having a specific pattern are present in a packet, what value or text is present at which location of a packet, a packet is received through which port and/or the source or destination of a packet has what value may be combined to form a security rule. According to the security rule, whenever a new security threat occurs, the type or characteristic of a new security threat corresponding to the network security system 100 and a corresponding security rule may be updated.

Meanwhile, it has been known that the full ruleset commonly includes 20,000 security rules or more. The number of security rules is inevitably increased whenever a new security threat occurs. Furthermore, although the intrusion detection/prevention module 110 or the conventional known IDS or IPS has any high performance, it is almost impossible to inspect the full ruleset in real time. There is practically a matter of degree. In general, an applicable security ruleset is set to a level 1/10 of the full ruleset. That is, the conventional network security systems perform inspection in real time by applying only some of a known full ruleset as an applicable security ruleset and do not perform inspection on the remaining security rulesets.

Accordingly, in this specification, the remaining security rulesets of applicable security rulesets are represented as a security vacuum in terms of operation. The security vacuum in terms of operation is an inevitably occurring security threat, but an effort for minimizing such a security vacuum in terms of operation was necessary. Such an effort includes, for example, a method of obtaining, by a security professional personnel, the trend of a security threat at corresponding timing and changing an applicable security ruleset for each period. However, to hire the security professional personnel is a big loss of a cost. Furthermore, even excellent security professional personnel cannot accurately know what security threats were actually present in a network, that is, a target of security, and cannot substantially optimize an applicable security ruleset.

The reason for this is that it is difficult to know that what security threat was actually present in addition to a security ruleset on which inspection had been performed in real time through the intrusion detection process, and in order to accurately know that the security threat was present in a corresponding network, after all packets are separately stored, inspection must be performed on the stored packets one by one as a full ruleset or most of security rulesets of the full ruleset. However, as described above, to store itself all packets passing through the network is a very high cost. Although packet inspection is performed on all the packets after they are stored as a full ruleset, a long time is inevitably taken. Furthermore, to check a result of the inspection after a long time and to change an applicable security ruleset may be inefficient.

Such a problem may be solved by a technical spirit which can significantly reduce stored packets and can have almost the same inspection results as that all packets are actually stored and inspected. The present invention can significantly reduce the number of stored packets and also obtain high-quality inspection results by providing such a technical spirit, can obtain fast inspection results by performing inspection on the stored packets as a full ruleset or a security ruleset (e.g., a security ruleset except an applicable security ruleset among the full ruleset) corresponding to a security vacuum in terms of operation, and can thus effectively increase the security of a network by adaptively changing an applicable security ruleset. Such a technical spirit may be achieved by a technical spirit in which only initial N (N is a natural number) packets of a specific session can be selected within a very short time and a technical spirit in which initial N packets of a selected session are selectively stored. Such technical spirits will be described later.

Meanwhile, if a new security threat occurs, it cannot be prevented although an applicable security ruleset is optimized. That is, when a new attack occurs, a security rule corresponding to the new attack is inevitably generated temporally after a given time. In this specification, the new security threat is defined as a “security vacuum in terms of time.” Furthermore, a technical spirit for minimizing such a security vacuum in terms of time may be made possible by efficiently storing only selected packets and searching for the stored packets at a high speed as described above. Such a technical spirit will be described later.

The packet storage module 120 may selectively extract at least some of a plurality of packets received from the packet extraction module 160.

Accordingly, the control module 130 may perform security inspection on the storage packets stored by the packet storage module 120. The security inspection for the storage packets may be a process of setting, as at least one inspection rule, a security rule other than applicable security rulesets and performing packet inspection. According to an implementation example, packet inspection may be performed on a full ruleset at packet inspection timing. Furthermore, the security inspection may be applied when the applicable security ruleset is inspected with respect to the storage packets. Alternatively, packet inspection may be performed on only the remaining security rules except the applicable security ruleset among the full ruleset.

The packet inspection for the storage packets may be performed after a given time from timing at which the intrusion detection/prevention module 110 performs packet inspection. Accordingly, a full ruleset at the timing at which the intrusion detection/prevention module 110 performs the packet inspection and a full ruleset at timing at which the control module 130 performs packet inspection on the storage packets may be different. Accordingly, according to an embodiment, if a new security rule is added to a full ruleset at timing at which packet inspection is performed on storage packets compared to a full ruleset at timing at which the intrusion detection/prevention module 110 performs packet inspection, the control module 130 may change an applicable security ruleset so that the new security rule must be set as an inspection rule with respect to the storage packets.

As a result, the control module 130 may set, as an inspection rule, at least one security rule not including an applicable security ruleset with respect to storage packets, may perform packet inspection, and may change an applicable security ruleset that is being applied based on a result of the execution of the packet inspection. Hereinafter, a case where the control module 130 performs inspection on storage packets as a full ruleset is described as an example, for convenience of a description.

If the control module 130 changes an applicable security ruleset, this may mean that at least one of a security rule included in an applicable security ruleset prior to the change and a security rule included in an applicable security ruleset after the change is different. Accordingly, the security rule included in the applicable security ruleset prior to the change may still be included in the security rule included in the applicable security ruleset after the change.

Furthermore, to change, by the control module 130, an applicable security ruleset may be a process of substituting a security rule included in the applicable security ruleset while maintaining the number of security rules included in the applicable security ruleset.

However, according to an implementation example, the control module 130 may also change the number of security rules to be included in an applicable security ruleset. For example, the control module 130 may perform packet inspection on storage packets for each period, and may increase the number of security rules if it is determined that a security threat is increased compared to the existing threat as a result of the packet inspection. In contrast, the control module 130 may reduce the number of security rules to be included in an applicable security ruleset based on a result of packet inspection for storage packets.

The control module 130 may control the intrusion detection/prevention module 110 to perform packet inspection on a changed applicable security ruleset as an inspection rule. For example, if the intrusion detection/prevention module 110 autonomously stores an applicable security ruleset, it may transmit information on a changed applicable security ruleset to the intrusion detection/prevention module 110. Alternatively, the control module 130 may store information on a changed applicable security ruleset at a given storage location. The intrusion detection/prevention module 110 may set, as an inspection rule, the applicable security ruleset stored at the storage location so that packet inspection can be performed. The control module 130 may change an applicable security ruleset using other various methods.

The DB 140 may mean information storage means for storing pieces of information necessary to implement the technical spirit of the present invention. The DB 140 may store information on a storage packet stored by the packet storage module 120 as described above, flow information and session information as will be described later. Furthermore, information on an applicable security ruleset may be stored in the DB 140. The DB 140 is sufficiently implemented as storage means for storing pieces of information necessary to implement the technical spirit of the present invention. Furthermore, the DB 140 does not need to be implemented as only one physical storage device and may be implemented as a plurality of physical storage devices. Furthermore, according to an implementation example, the DB 140 may be implemented as a physical device separated from the network security system 100. The network security system 100 may access the DB 140 over the network.

The packet search module 150 may perform a function for searching for a packet stored in the DB 140. In this case, high-speed Downdrill search may be made possible as will be described later. Furthermore, there is an effect in that a security vacuum in terms of time can be reduced through such high-speed packet search.

FIG. 2 is a diagram for schematically describing a network security method according to an embodiment of the present invention.

Referring to FIG. 2, for the network security method according to an embodiment of the present invention, the effective and selective storage of input traffic may be performed by the network security system 100 (S100). A technical spirit for detecting a session and extracting only initial N preceding packets of the session may be used for the selective storage. Furthermore, as will be described later, in order to extract the initial N preceding packets of the session at a high speed, a technical spirit using flow information may be provided. The selective storage of the input traffic may be performed by the packet storage module 120.

Meanwhile, an intrusion detection or prevention process may be performed by the network security system 100 in real time (S100-1). The intrusion detection or prevention process, as described above, may be performed by performing the passage of a selective packet through real-time packet inspection based on an applicable security ruleset. The network security system 100 may select some security rulesets, selected using a given method among a full ruleset, as applicable security rulesets in the intrusion detection or prevention process, and may apply the selected security rulesets as inspection rules for the intrusion detection or prevention process. Such an initial applicable security ruleset may be performed randomly or by a given security manager.

Accordingly, the network security system 100 may perform security inspection on a storage packet (S110). The security inspection on the storage packets may be inspection for determining whether the storage packet is a packet corresponding to the security rule. As described above, the full ruleset may be applied, but the present invention is not limited thereto. At least one security rule not included in an applicable security ruleset being now applied to the intrusion detection or prevention process at least may be used as an inspection rule in security inspection for the storage packet.

The security inspection for the storage packet may be performed in a given period unit (e.g., day/week). As such a period is fast, an action for a security vacuum in terms of operation can be taken more instantly. Furthermore, in order to reduce such a period, efficient packet storage needs to be performed so that the number of storage packets is reduced and quality of packet inspection is increased.

Accordingly, the network security system 100 may change an applicable security ruleset based on a result of the inspection (S120). The change of the applicable security ruleset may be a change for including a security rule by which a corresponding packet can be detected if the corresponding packet not detected as a current set applicable security ruleset is detected in the security inspection process S110 for the storage packet, for example.

An example of a change in the security rule may be the least recently used (LRU) method. That is, this method may be a method of including a new security rule in an applicable security ruleset instead of excluding the least recently used (i.e., a security threat corresponding to a corresponding security rule is not detected) security rule from an applicable security ruleset. However, a person having ordinary knowledge in the art may easily reason that such a detailed method of changing an applicable security ruleset may be various.

Meanwhile, the network security system 100 may adaptively adjust the number of security rules to be included in an applicable security ruleset and/or a security inspection period for a storage packet. Such adjustment may be adaptively performed based on the strength of a security threat (e.g., detected attack or the number of packets) based on a result of the security inspection process S110 for the storage packet.

For example, the adjustment of the number of security rules included in the applicable security ruleset may be performed within a range that does not severely degrade performance of a network. Furthermore, the security inspection period for the storage packet may be shortly adjusted if it is determined that the strength of a security threat is great and may be lengthily adjusted in an opposite case.

If the applicable security ruleset is changed, the intrusion detection or prevention process may be performed based on the changed applicable security ruleset.

As a result, according to the technical spirit of the present invention, there are effects in that a security vacuum in terms of operation can be minimized and an adaptive security policy can be performed based on a security threat actually performed in a network.

Meanwhile, a concept in which a packet is selectively stored by the packet storage module 120 is described below. According to the technical spirit of the present invention, the packet storage module 120 may extract and store only the N preceding packets of a session at a high speed. To this end, there is provided a technical spirit for extracting initial N preceding packets of the session using a flow.

The packet storage module 120 may include a flow generation module 121 and a session generation module 122.

The flow generation module 121 may generate a plurality of flows based on packets received by the packet extraction module 160. The packet extraction module 160 may sequentially output the packets to the flow generation module 121. Accordingly, the flow generation module 121 may generate a flow. To generate the flow may mean that flow information is generated as will be described later. According to an implementation example, the flow generation module 121 may selectively extract a packet included in a flow and store the packet in the DB 140. The flow generation module 121 may enable all packets, corresponding to a given flow, to be stored. However, according to an implementation example, as will be described later, only initial some packets of a session including a flow may be finally stored in the DB 140.

The flow generation module 121 may temporarily store, in the DB 140, a flow and all packets included in the corresponding flow. The session generation module 122 may selectively store only some of the stored packets and may detect the remaining packets.

In this specification, the flow means a set of IP packets consecutively transmitted within a limited time. Accordingly, an IP flow may be defined as a flow of IP packets consecutively transmitted within a limited time, which are specified by an address pair (transmitter address, transmitter port number, receiver address, receiver port number) of an application, a host pair (transmitter network address and receiver network address), and an AS number pair (transmitter AS number and receiver AS number). The concept of a flow and a method of forming a flow have been specifically disclosed in Prior Art Document, and a detailed description thereof is omitted in this specification. Furthermore, in this specification, the concept of a flow and the method of generating a flow include the technical spirit and description disclosed in Prior Art Document as the reference of this specification, and may be treated as being included in the description of this specification.

A 5-tuple may be used as an example for generating a flow among the attributes of packets. That is, the flow generation module 121 may receive packets over a network, and may generate a flow, that is, consecutive sets of the packets, or may extracts some of the packets that form the flow. In a condition for generating the flow or detecting the flow packets, the attributes of packets (e.g., 5-Tuple (Source Address, Destination Address, Source Port, Destination Port, Protocol)) are compared. If a packet having the same attribute (e.g., 5-tuple value) is not present as a result of the comparison, a new flow is generated. If a packet having the same value is present, flow information of the flow may be updated.

The consecutive sets of the packets do not mean packets that are essentially physically consecutive, but may be used as a meaning that the attribute of a packet reached within a temporally limited time includes the same packet.

The flow information includes 5-tuple information of a packet, and may include a flow size, duration, that is, the start time (S.T) and end time (E.T) of a flow, a packet count (P.C), an average packet size, an average rate, a flag (e.g., a special signal (SYN, FIN, etc.) for a protocol) and/or a flow size. The flow information may be output and stored in the DB 140. The flow generation module 121 may store, in the DB 140, flow information of a given flow and a packet included in the flow so that they correspond to each other. Such a process may be defined that the flow generation module 121 generates a flow. For example, flow information and a packet included in a flow may be stored so that they are physically consecutive. Although flow information and a packet included in a flow are physically separated like a table or a link, they may be stored in various forms in which the flow information and the packet can be easily searched for.

Some of packets stored as described above may be deleted based on session information generated by the session generation module 122. That is, some of the packets except initial N preceding packets of a session may be deleted. Accordingly, according to an implementation example, only flow information may be stored with respect to a specific flow, and a packet corresponding to the specific flow may not be stored.

When the plurality of flows is stored in a storage device (e.g., the DB 140), that is, the plurality of flows is generated by the flow generation module 121, the session generation module 122 may generate a session based on information on the plurality of flows. To generate the session may mean that flows forming the same session among the plurality of generated flows are extracted and session information including ID information for the extracted flows is generated and stored in the DB 140. Furthermore, to generate the session may be a meaning including a process of storing only initial N preceding packets of packets included in a session, together with session information, so that the initial N preceding packets correspond to the session information. The process of storing the preceding packets so that they correspond to the session information may mean a process of deleting packets, stored by the flow generation module 121, except the preceding packets. Alternatively, the session information and the preceding packets may be separately stored. In such a case, the preceding packets may be doubly stored.

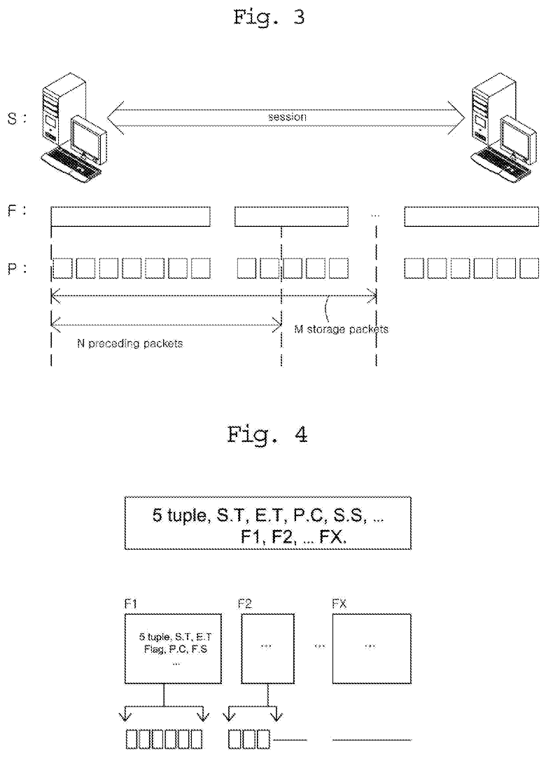

A concept in which the session generation module 122 generates the session is described with reference to FIG. 3.

FIG. 3 is a diagram for describing a session, a flow, and packets for a method of providing a network security system according to an embodiment of the present invention.

Referring to FIG. 3, when given devices set up a session S, the session S may be configured with at least one flow F. Furthermore, the at least one flow may be configured with at least one packet P.

According to a technical spirit of the present invention, the network security system 100 may collect packets that pass through one point in a given network. This may be performed by the packet extraction module 160.

Furthermore, the network security system 100 may generate a flow based on packet attributes (e.g., 5 tuple) of the collected packets. A method of generating a flow is the same as that described above. The generation of the flow may be performed by the flow generation module 121. Each flow may be configured with only one packet or may be configured with a plurality of packets. Furthermore, a flow size may be different for each flow.

When the flow is generated as described above, the session generation module 122 may generate a session. Furthermore, the session generation module 122 may selectively store some or all of the plurality of packets in the storage device or the DB 140 based on the generated session.

To this end, at least one packet storage mode may be provided to the network security system 100.

The packet storage mode provided according to a technical spirit of the present invention may provide a mode in which only initial N packets of a session at least is stored.

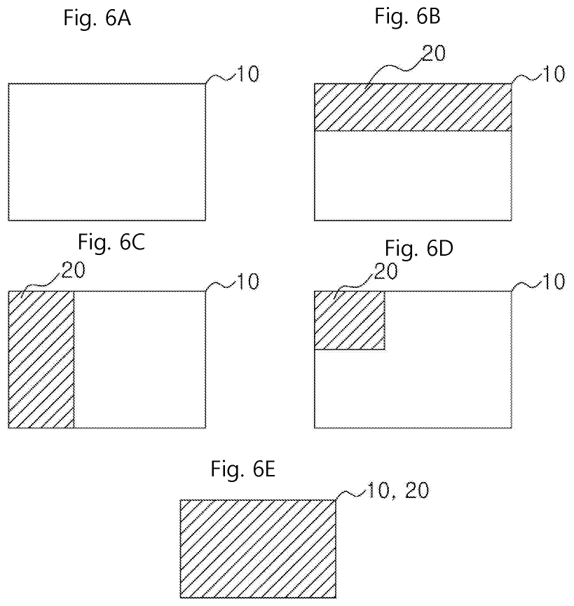

According to an implementation example, a mode in which only all or some (e.g., N) of packets forming a session with respect to a predetermined type of the session are stored may be provided. According to an implementation example, a mode in which all packets included in a session (all sessions or a predetermined type of session) are stored may be provided. The network security system 100 does not randomly store packets with respect to each mode, but may provide a packet storage mode according to a session based on session information generated by the session generation module 122. An example of the packet storage mode will be described later with reference to FIGS. 6A-6E.

In order to generate the session, the session generation module 122 may identify flow information stored in the DB 140. Flows included in the same session may have a common characteristic. Accordingly, the session generation module 122 may search for flows having a common characteristic among flows stored in the DB 140. Furthermore, the session generation module 122 nay check temporal priority of each flow based on flow information (e.g., information, such as S.T, E.T, etc. included in the flow information). The session generation module 122 may check the best flow and last flow of a corresponding session based on flag information included in flow information of each session setup flow.

Accordingly, the session generation module 122 may extract at least one flow, that is, a session setup flow included in a specific session. The session setup flow may be one flow, and may include a plurality of flows.

The reason for this is that as described above, the network security system 100 according to the technical spirit of the present invention does not generate only a flow and all of important characteristics of a session can be checked based on initial N (N is a natural number) preceding packets of the session If the session is generated based on a generated flow.

Accordingly, in conventional prior arts, all of collected packets are stored and inspected (e.g., DPI) or a given number of preceding packets are stored and inspected for each flow. In contrast, a characteristic or desire information of a given application cam be inspected based on only a smaller number of security inspections. In general, it has been known that although only about initial 5 packets of a session are inspected, there is no significant difference in quality of inspection compared to the inspection of all packets included in the session.

As described above, at least one packet storage mode may be provided based on the characteristics of a network or the strength of security. The session generation module 122 may store a packet so that the packet corresponds to a current setting mode among the at least one packet storage mode.

Furthermore, according to a technical spirit of the present invention, there is an effect in that the number of packets, that is, a target of the inspection of a security inspection process for a storage packet, can be reduced. Accordingly, there is an effect in that a gain for storage can be obtained.

Furthermore, as in the technical spirit of the present invention, if a flow is generated from a packet and a session is generated using the generated flow, there is an effect in that high-speed packet search is possible although a specific service user searches for a packet. That is, the network security system 100 does not store only initial N preceding packets of a session, but may store all of collected packets. In such a case, there is an effect in that high-speed Downdrill search is possible because a session corresponding to a desired packet can be searched for by first searching for session information generated by generating a session, a flow corresponding to the desired packet is searched for in the retrieved session, and the packet is searched for based on the retrieved flow. The reason for this is that if only a flow is generated, in the worst case, after search is performed as many as the number of flows, a packet may be searched for, but if a session has been formed, in the worst case, after search is performed as many as the number of sessions, a flow and packet corresponding to the corresponding packet may be searched for within a short time. Although only initial N preceding packets are stored, such an effect is still present. Furthermore, a service user who wants to search for a packet may be aware of information on a session, but may not be aware of information on a flow. Accordingly, as in the technical spirit of the present invention, if a session is generated, there is an effect in that efficient and high-speed packet searching in a network recording service is possible.

According to an implementation example, the session generation module 122 included in the network security system 100 may store M packets, that is, M storage packets greater than N preceding packet among collected packets. In such a case, the network security system 100 may perform security inspection on the preceding packets only. Furthermore, the possibility that a desired packet can be searched for even in packet search in addition to security inspection can be increased by storing the M storage packet. M may be adaptively set depending on the type of service, the needs of a service user or the type of application in which a session is used.

Referring back to FIG. 1, the session generation module 122 may generate a session based on a plurality of flows generated by the flow generation module 121. That is, session information may be generated.

The session information may include at least one flow included in at least a session, that is, the index (ID information) of each of session setup flows. Furthermore, various pieces of information indicative of the characteristics of the session may be included in the session information.

Through the generation of such session information, high-speed packet searching may be possible as described above. Furthermore, through the generation of a session, only initial N preceding packets of the session can be specified.

A conceptual structure in which packets are stored according to the present invention is described as follows with reference to FIG. 4.

FIG. 4 is a diagram for describing a concept in which packet search according to a method of providing a network security system according to an embodiment of the present invention is performed.

Referring to FIG. 4, the session generation module 122 may generate a given session as described above. Session information generated through the generation of the session may include at least ID information of session setup flows included in the session as shown in FIG. 4.

Furthermore, the session information may further include information on the 5-tuple of the session and information on a start time (S.T) and an end time (E.T), a packet count (P.C), a session size (S.S), etc.

The packet search module 150 included in the network security system 100 may first search for a session corresponding to a packet search request in response to the packet search request received from the terminal (not shown) of a service user. The packet search request may include at least one piece of information included in session information. For example, a transmitter address, a receiver address, and time information may be included in the packet search request.

Accordingly, the packet search module 150 may search for a flow corresponding to the packet search request by searching for flow information of each of session setup flows included in the session information. Furthermore, when the flow corresponding to the packet search request is searched for, the packet search module 150 may easily search the DB 140 for a packet corresponding to the packet search request. According to an implementation example, if the network security system 100 stores only a preceding packet, a packet corresponding to the packet search request may not be present. Furthermore, if all packets are stored, the search of a packet corresponding to the packet search request may be guaranteed.

As a result, the technical spirit of the present invention has an effect in that after a flow is generated from a packet and a session is generated from the flow, when a packet is searched for, high-speed Downdrill search is made possible in order of the session, the flow, and the packet.

Such high-speed search has an effect in that a security vacuum in terms of time can be reduced. That is, it is very important to rapidly take an action against a target network or target system that has experienced an attack due to a security vacuum in terms of time. The reason for this is that packet search based on a security vacuum in terms of time must be rapidly performed.

Referring back to FIG. 1, the control module 130 may perform security inspection on packets stored by the session generation module 122. According to an example, the session generation module 122 may store only preceding packets in the storage device or the DB 140 for each session. In such a case, the session generation module 122 may perform security inspection on preceding packets of each session. A method of performing security inspection may be various. For example, conventional deep packet inspection (DPI), etc, may be used. A result of the inspection of the control module 130 may be stored in the DB 140. Furthermore, since the control module 130 can perform security inspection on only preceding packets, security inspection for a session can be completed in real time before the session is terminated.

Furthermore, as described above, according to the technical spirit of the present invention, if only a predetermined number of preceding packets are stored for each session, packets in a current network can be inspected in real time and the past packets (i.e., previously stored preceding packets) can be inspected at a high speed. That is, there is an effect in that network inspection can be retroactively performed on the past. In such a case, there is an effect in that although a network attack was performed, at least the fact that the network attack was performed can be checked at a high speed and an attacked system (e.g., the destination of packets) can be notified of the fact.

Meanwhile, according to the technical spirit of the present invention, as described above, the network security system 100 may be used for network recording service. Conventionally, all of collected packets must be store for network recording. In contrast, according to the technical spirit of the present invention, the number of storage packets can be significantly reduced and pieces of important information can be stored because a session is formed and only initial N preceding packets of the session are stored. M storage packets may be stored according to needs for service. Even in such a case, there is a storage reduction effect compared to a case where all packets are collected/stored.

Furthermore, according to the technical spirit of the present invention, the network security system 100 may store only packets corresponding to a predetermined type of session. For example, the network security system 100 may perform network recording on only a predetermined session, such as an HTTP or a TCP session.

A function for performing network recording on only a predetermined session as described above may be performed by the flow generation module 121 and may be generated by the session generation module 122. For example, the flow generation module 121 may generate a flow for only packets corresponding to a predetermined session among packets collected by the packet extraction module 160. Alternatively, after the flow generation module 121 generates the flow for all packets, the session generation module 122 may delete, from the DB 140, a flow not corresponding to the predetermined session among the generated flows.

Whether a flow corresponding to the predetermined session may be determined based on port information of packets. That is, a port number may be bound based on the type of session. Whether a packet or flow corresponds to the predetermined session may be determined based on the port number.

According to an implementation example, the packet extraction module 160 may transmit, to the flow generation module 121, only a packet corresponding to the predetermined session.

In either case, the network security system 100 may perform network recording on only the predetermined session.

As a result, according to the technical spirit of the present invention, the absolute number of stored packets can be reduced compared to conventional network recording, and network recording can be performed on only a desired session.

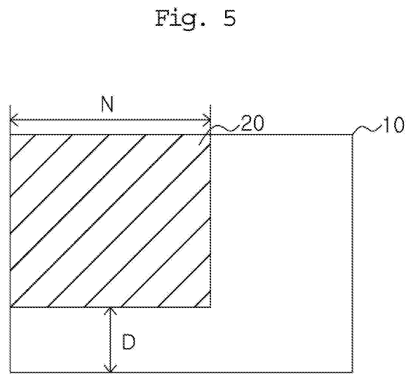

This may be diagrammatically shown like FIG. 5. FIG. 5 is a diagram for describing an effect according to a method of providing a network security system according to an embodiment of the present invention.

Referring to FIG. 5, the transverse axis of a rectangle conceptually indicates a session size, and the longitudinal axis thereof conceptually indicates sessions. Accordingly, the rectangle 10 shown in FIG. 5 may mean the number of stored packets if all of collected packets are stored.

The network security system 100 according to the technical spirit of the present invention has an effect in that the number of packets stored for each session can be reduced because all packets included in a specific session are not stored, but only N preceding packets (or M storage packets) can be stored.

Furthermore, the network security system 100 according to the technical spirit of the present invention has an effect in that packets for sessions (corresponding to D) not corresponding to a predetermined type may not be stored because packets for all sessions are not stored, but packets for only a predetermined type of session can be stored.

As described above, according to the technical spirit of the present invention, there is an effect in that high-speed packet search is made possible because the absolute number of packets is reduced and only packets meaningful for security inspection are selectively stored. Furthermore, there is an effect in that high-speed packet search is made possible through Downdrill search in order of session information and flow information as described above.

FIGS. 6A-6E are diagrams for describing a plurality of packet storage modes through a method of providing a network security system according to an embodiment of the present invention.

Referring to FIGS. 6A-6E, the transverse axis of a rectangle conceptually indicates a session size, and the longitudinal axis thereof conceptually indicates sessions. Accordingly, the rectangle 10 shown in FIGS. 6A-6E may mean the number of stored packets if all of collected packets are stored. A slashed region 20 may indicate the number of packets actually stored by the session generation module 122.

First, FIG. 6A may indicate a case where a packet is not stored. According to the technical spirit of the present invention, such a case may indicate a case where packets are inspected in real time. In this case, a function, such as the conventional DPI, may be performed. However, even in this case, according to the technical spirit of the present invention, there are effects in that a session can be generated and only preceding packets of the generated session can be inspected at a high speed.

FIG. 6B conceptually shows a case where all the packets of a session are inspected with respect to a predetermined type of session. FIG. 6C conceptually shows a case where initial N preceding packets are stored with respect to all sessions.

FIG. 6D conceptually shows a case where initial N preceding packets are stored with respect to a predetermined type of session. Furthermore, FIG. 6E conceptually shows a case where all packets are stored with respect to all sessions.

As described above, the network security system 100 provides at least one packet storage mode, such as that shown in FIGS. 6A-6E. The network security system 100 may adaptively store a packet according to a setting mode set for a current network. The setting mode may be adaptively selected based on the characteristics of a network or required strength of security.

Furthermore, the packet storage mode may be differently applied to each session.

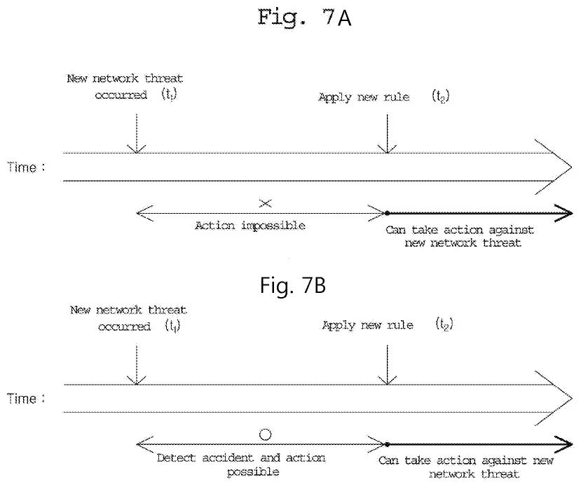

FIGS. 7A and 7B are diagrams for describing a concept in which the past network attack can be effectively inspected according to an embodiment of the present invention.

That is, FIGS. 7A and 7B are diagrams for describing a concept capable of reducing a security vacuum in terms of time. First, FIG. 7A illustrates an operation concept of a conventional network security system (e.g., DPI). For example, at given timing (t1), a new network threat may occur. A network inspection rule (e.g., a packet signature indicative of the new threat) corresponding to the new network threat may be set at timing (t2) after a lapse of a given time. In such a case, a conventional network security system only can handle the new network threat after the timing (t2). That is, there is a problem in that a network attack cannot be recognized although the network attack is actually present between the timing (t1) and the timing (t2).

Even in a conventional technology, if both a network inspection system (e.g., DPI) and a network recording system are used, a network attack between the timing (t1) and the timing (t2) may be recognized. However, even in such a case, in conventional network recording, a larger number of packets must be stored compared to the technical spirit of the present invention. Accordingly, there was a problem in that the past network attack cannot be recognized and an action cannot be taken at a high speed.

In contrast, according to a network inspection method according to the technical spirit of the present invention, such as that shown in FIG. 7B, there is an effect in that network recording can be performed by only the storage of a small number of packets while network recording is performed between the timing (t1) and the timing (t2). Accordingly, there are effects in that retroactive network inspection can be performed on the past network at a high speed and an action against an attacked target can be rapidly taken. High-speed network inspection can be performed in real time after the timing (t2).

The network security method according to an embodiment of the present invention may be implemented in the form of computer-readable program instructions and stored in a computer-readable recording medium. A control program and target program according to embodiments of the present invention may also be stored in a computer-readable recording medium. The computer-readable recording medium includes all types of recording devices in which data readable by a computer system is stored.

The program instructions written in the recording medium may have been specially designed or configured for the present invention or may have been known to and available by a person skilled in the software field.

Examples of the computer-readable recording medium include hardware devices specially configured to store and execute program instructions, such as magnetic media such as a hard disk, a floppy disk and a magnetic disk, optical media such as CD-ROM and a DVD, magneto-optical media such as a floptical disk, ROM, RAM, and flash memory. Furthermore, the computer-readable medium may be distributed to computer systems connected over a network, and computer-readable code may be stored and executed in a distributed manner.

An example of the program instructions includes a high-level language code executable by a device for electronically processing information using an interpreter, for example, a computer, in addition to a machine code, such as that produced by a compiler.

The aforementioned hardware device may be configured to operate as one or more software modules in order to perform an operation of the present invention and vice versa.

The aforementioned description is illustrative, and those skilled in the art to which the present invention pertains will appreciate that the present invention may be implemented in other detailed forms without changing the technical spirit or essential characteristics of the present invention. Accordingly, the aforementioned embodiments should be construed as being only illustrative not as being restrictive from all aspects. For example, each of the elements described in the singular forms may be distributed and implemented. Likewise, elements described as being distributed may also be implemented in a combined form.

The scope of the present invention is defined by the appended claims rather than the detailed description, and the present invention should be construed as covering all modifications or variations derived from the meaning and scope of the appended claims and their equivalent.

The present invention may be used for a network security system and method for performing adaptive ruleset setting.

1. A network security method of performing adaptive ruleset setting, comprising:
performing, by a network security system, an intrusion detection or prevention process of detecting a security threat or allowing only a permitted packet to pass therethrough among a plurality of packets received from a network based on a preset applicable security ruleset and a packet storage process of selectively storing at least some of the plurality of packets; and
changing, by the network security system, the applicable security ruleset to be applied to the intrusion detection or prevention process from a first security ruleset to a second security ruleset based on storage packets stored through the packet storage process.

2. The network security method of claim 1, wherein the performing, by the network security system, the intrusion detection or prevention process of detecting a security threat or allowing only a permitted packet to pass therethrough among the plurality of packets received from the network based on the preset applicable security ruleset and the packet storage process of selectively storing at least some of the plurality of packets comprises a step of performing, by the network security system, the packet storage process of storing only N (N is a natural number) preceding packets of a session among session setup packets forming the session from the plurality of packets.

3. The network security method of claim 1, wherein the changing, by the network security system, the applicable security ruleset to be applied to the intrusion detection or prevention process from the first security ruleset to the second security ruleset based on the storage packets stored through the packet storage process comprises:
performing security inspection on the storage packets stored for a given period; and
changing the applicable security ruleset to be applied to the intrusion detection or prevention process from the first security ruleset to the second security ruleset based on a result of the execution of the security inspection.

4. The network security method of claim 3, wherein the step of changing the applicable security ruleset to be applied to the intrusion detection or prevention process from the first security ruleset to the second security ruleset based on a result of the execution of the security inspection comprises:
determining at least one second security rule to be included in the second security ruleset based on a result of the execution of the security inspection; and
specifying the second security ruleset by newly adding the determined at least one second security rule to the first security ruleset or substituting the determined at least one second security rule with at least one first security rule included in the first security ruleset.

5. The network security method of claim 4, wherein the newly adding the determined at least one second security rule to the first security ruleset or substituting the determined at least one second security rule with the at least one first security rule included in the first security ruleset and specifying the second security ruleset comprises a determining the at least one first security rule to be substituted in order of a least recently used security rule by which a security threat has not been detected among security rules included in the first security ruleset.

6. The network security method of claim 3, further comprising changing the period based on a result of the execution of the security inspection or changing number of security rules to be included in the applicable security ruleset.

7. The network security method of claim 2, further comprising:
generating, by the network security system, a plurality of flows formed by the plurality of packets based on the plurality of packets; and
extracting, by the network security system, at least one session setup flow forming an identical session among the plurality of flows based on information on the plurality of generated flows and specifying session information and the preceding packet based on the extracted session setup flow.

8. A network security method of performing adaptive ruleset setting, comprising:
performing, by a network security system, a packet storage process of selectively storing at least some of a plurality of packets received from a network; and
detecting, by the network security system, a security threat based on a preset applicable security ruleset or changing, from a first security ruleset to a second security ruleset, the applicable security ruleset to be applied to an intrusion detection or prevention process of or allowing only a permitted packet to pass therethrough.

9. A computer program written in a medium installed on a data processing unit, for performing a method according to claim 1.

10. A network security system performing adaptive ruleset setting, comprising:
an intrusion detection/prevention module performing an intrusion detection or prevention process of detecting a security threat or allowing only a permitted packet to pass therethrough based on a preset applicable security ruleset among a plurality of packets received from a network;
a packet storage module performing a packet storage process of selectively storing at least some of the plurality of packets; and
a control module for changing, from a first security ruleset to a second security ruleset, an applicable security ruleset to be applied to the intrusion detection or prevention process based on storage packets stored through the packet storage process.

11. The network security system of claim 10, wherein the packet storage module performs the packet storage process of storing only N (N is a natural number) preceding packets of a session among session setup packets forming the session from the plurality of packets.

12. The network security system of claim 10, wherein the control module performs security inspection on the storage packets stored for a given period and changes the applicable security ruleset to be applied to the intrusion detection or prevention process from the first security ruleset to the second security ruleset based on a result of the execution of the security inspection.

13. The network security system of claim 12, wherein the control module determines at least one second security rule to be included in the second security ruleset based on a result of the execution of the security inspection, and specifies the second security ruleset by newly adding the determined at least one second security rule to the first security ruleset or substituting the determined at least one second security rule with at least one first security rule included in the first security ruleset.

14. The network security system of claim 13 wherein the control module determines the at least one first security rule to be substituted in order of a least recently used security rule by which a security threat has not been detected among security rules included in the first security ruleset.

15. The network security system of claim 12, wherein the control module changes the period based on a result of the execution of the security inspection or changes number of security rules to be included in the applicable security ruleset.

16. (canceled)

17. (canceled)
